(19) United States
(12) Patent Application Publication
(10) Pub. No.: US 2006/0239746 A1
(43) Pub. Date: Oct. 26, 2006

(54) Systems and methods for computer input

(75) Inventor: Bruce D.R. Grant, Moscow (RU)

Correspondence Address: BAKER & MCKENZIE LLP;PATENT DEPARTMENT, 2001 ROSS AVENUE, SUITE 2300, DALLAS, TX, 75201, US

(73) Assignee: iKeyInfinity Inc., Moscow (RU)

(21) Appl. No.: 11/110,226

(22) Filed: Apr. 20, 2005

(51) Int. Cl. B41J 5/00

(52) U.S. Cl. 400/490

(57) ABSTRACT

A display device, such as a liquid crystal display, can be integrated into each key of a keyboard, numeric keypad, or other keyed input device. The display device can display a symbol when it is active. For example, a “1” when pressing that key will input a “1” and a “!” when that key input a “!.” In addition to a display device, each key top can include a key cap, generally made of a transparent plastic so that the display can be seen. The key cap can be formed in the shape of a key and will generally be the portion of the input device that a user presses on to input information. A plurality of key caps can be combined to form a keyboard, numeric keypad, or other keyed input device. Throughout the rest of this application the term keyboard will generally be used in place of keyboard, numeric keypad, or other keyed device. In another embodiment a display device can be overlaid with a key cap skin to form a keyed input device, such as a keyboard. The display device can be a touch sensitive screen. Each key on the key cap skin can be pressed to input information displayed on the touch sensitive screen below. The key cap skin provides keys that are tactilely discernible without activating the keys. Individual keys can be located and distinguished from adjacent keys by touch.

### BACKGROUND

1. Field of the Inventions

The field of the invention relates generally to computer input devices and more particularly to keyboards.

2. Background Information

Information can be input into computers and other electronic devices using a keyboard or keypad. Generally, the keyboard or keypad includes a static symbol on each key according to a specific alphabetic or functional layout. In certain layouts, the keys can include multiple static symbols to indicate multiple functions. For example, on many computer keyboards in the United States the “1” and the “!” are displayed on the same key. When the “1” key is pressed a “1” can be input into the computer, however; when the “Shift Key” and the “1” key are pressed together a “!” can be input into the computer.

In certain layouts, the keyboard keys can have more than two functions. As with the example above, the additional function can be accessed by depressing a key along with one or more other keys, such as the Shift key, Control key, and Alternate key; however, space on a typically keyboard key can be limited and therefore, it may be difficult to display all of the functions that a key can perform. As a result, in many layouts, not all of the functions that a given key can perform are displayed on the key. Accordingly, the user must keep track of all of the different functions that all of the different keys perform.

Additionally, electronic devices, such as computers, can, in some cases function in more than one language, or include special fonts that display different symbols. The wide variety of languages can cause manufacturers to produce specialized keyboards that can include special symbols on each key. These specialized keyboards can create some discomfort for users, for example, when a user must deal with multiple languages. In these cases, the user may have to change keyboards, or remember different key functions without the aid of having symbols representing that function printed on the key.

Several different solutions to the problems identified above have been proposed, including transparent or opaque plastic overlays, keyboard “kidgloves” or silicone “skin,” interchangeable key sets, custom keycaps, and specially manufactured keyboards. These solutions are, however, limited. Transparent or opaque plastic covers can be used to customize a keyboard, but can be difficult to change from application to application. Keyboard “kidgloves” or silicon “skins” can be cumbersome. Interchangeable key sets can be time consuming to change. Specially manufactured keyboards or customized keyboards can also be cumbersome since different keyboards for different applications need to be stored between each use.

### SUMMARY OF THE INVENTION

A keyboard can comprising keys that include an integrated display device, such as a liquid crystal display. Each key can have multiple functions assigned to it and the display device can be configured to display an icon associated with the function that is currently active for the key.

In one aspect, each key top can include a key cap, generally made of a transparent plastic so that the display can be seen. The key cap can be formed in the shape of a key and will generally be the portion of the input device that a user presses on to input information. The display can generally be under the key cap and additionally support circuitry for the display can also be included, as discussed below.

In another aspect, the keyboard can incorporate a Universal Serial Bus (USB) interface so that information can be transmitted from the keyboard to another electronic device, such as a computer.

In another aspect, the keyboard can include a central processing unit, such as a microprocessor. The processor can execute instructions necessary to control the display device or devices, and any other keyboard functions. The processor can be connected to a memory for storing instructions. Additionally, the processor can use the memory for data buffering, storing character maps, and storing information to be displayed on the keyboard keys.

In another aspect a display device can be overlaid with a key cap skin to form a keyboard. The display device can be a touch sensitive screen. Each key on the key cap skin can be pressed to input information displayed on the touch sensitive screen below. The key cap skin provides keys that are tactilely discernible without activating the keys. Individual keys can be located and distinguished from adjacent keys by touch.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating components that comprise an example key configured in accordance with one embodiment;

FIG. 2A is a diagram illustrating the components of FIG. 1 assembled to form a key;

FIG. 2B is a diagram illustrating the key of FIG. 2A in a depressed position;

FIG. 3 is a diagram illustrating a top view of the key of FIG. 2A;

FIG. 4 is a diagram illustrating an example display that can be included in the components of FIG. 1;

FIG. 5 is a diagram illustrating pixels comprising the display of FIG. 4;

FIG. 6A-C are diagrams illustrating a portion of a keyboard that includes the key of FIG. 2A;

FIG. 7 is a diagram illustrating a system that includes the keyboard of figures 6A-6C;

FIG. 8 is a block diagram illustrating various components of the keyboard of FIGS. 6A-6C; and

FIG. 9 is a diagram illustrating a side view of a keyboard that includes the key of FIG. 2A.

### DETAILED DESCRIPTION

A typical computer can often have 2, or more associated functions with corresponding symbols on the keys themselves. For purposes of this specification and the claims that follow, the term “keyboard” will be used to refer to keyboards, keypads, and any user interface that has “keyed” inputs that correspond to various functions. Having multiple symbols on the keys can require that the symbols be smaller, which can make them harder to read. Additionally, in some cases, it can be difficult to know which symbols are active at a given time. As an example, consider the key for the letter “c” on a typical computer running one of several popular word processing programs. The single key can cause a lower case “c,” an upper case “C,” or a “copy” function depending on which other keys are pressed in conjunction with the “c” key.

A standard computer keyboard can have at least five modifier keys. For example, “Shift,” “Command,” “Option,” “Control,” “Caps-Lock,” and “Function.” On many conventional keyboards, the “Shift” layout is visible on the keys, i.e. the upper case letters. In some cases, as discussed above other layouts, such as the function layout can also be shown on the face of a key. Again, however, printing the symbols for multiple layouts on the keys requires that the symbols be printed small enough to fit on the keys, which can them difficult to read. Moreover, it is often the case that not all of the symbols can or are printed on the keys.

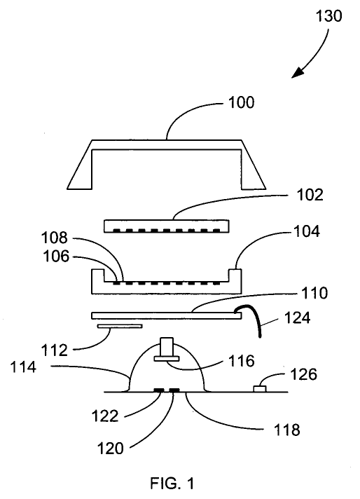

In the systems and methods described herein, however, a display device is incorporated into the keys and configured to display the active function. FIG. 1 is a diagram illustrating example components comprising a key 130 configured in accordance with one embodiment of the systems and methods described herein. Key 130 can include a key cap 100, this can be the top portion that a user presses. Key cap 100 can be a plastic piece and can be opaque or clear. A display 102 can be positioned under key cap 100. By using an opaque or clear material to form key cap 100 a user can see display device 102 below key cap 100. Display 102 can be a liquid crystal display, a micro-electromechanical system display or other display device and can be configured to display a symbol corresponding to a function that is currently active for key 130.

Display 102 can be mounted in an elastometric connector 104. Elastometric connector 104 is an interconnect device with alternating conductive 106 and nonconductive 108 layers sandwiched together. Conductive layers 106 can, for example, be oriented vertically and make contact with the display device from the bottom.

Elastometric connector 104 can be mounted on a control circuit board 110 to electrically connect control circuit board 110 to display device 102. Control circuit board 110 can include a controller 112 that can be mounted on control circuit board 110 and can be configured to control display device 102. Controller 112 can be an electronic device, such as an integrated circuit that can control what is displayed on display 102, for example, in one embodiment that uses a LCD for display 102 controller 112 can be an LCD Driver.

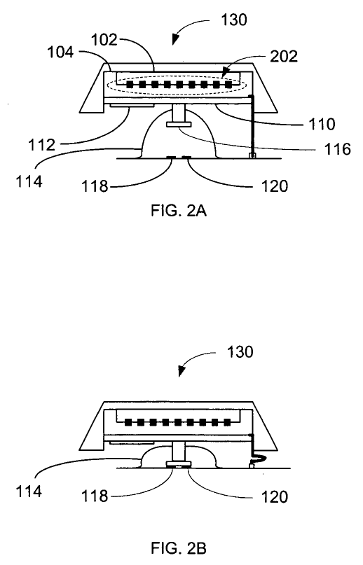

A key switch can be placed under control circuit board 110. The key switch can provide an electrical contact when key 130 is pressed and can be, for example, a rubber dome switch 114. When key 130 is pressed a conductive portion 116 of rubber dome switch 114 can be pressed into a circuit board 118 that includes, e.g., a pair of conductive traces 120, 122. Conductive portion 116 can electrically connect conductive traces 120, 122. This electrical connection can cause information to be input into an electronic device, such as a computer, connected to the keyboard. FIG. 2B, discussed below illustrates this connection in more detail.

A connecting cable 124 can connect control circuit board 110 to circuit board 118 through connector 126. Connecting cable 124 can provide power and ground to control circuit board 110, which can, in turn, provide power and ground to display 102. Power and ground provide the electrical current necessary for the electronic devices to operate. Additionally, information regarding the active function can be transmitted through connecting cable 124. For example, other key presses, such as “Shift”, “Ctrl”, and “Caps Lock” can be transmitted to key 130 using connecting cable 124.

FIG. 2A is a diagram illustrating the components of key 130 assembled and interfaced with key switch 114. As discussed above, display 102 can be electrically connected to control board 110 through elastometric connector 104. An example connection is illustrated at connection 202. Connection 202 illustrates a conductive portion on the bottom of display device 102 contacting a conductive portion of elastometric connector 104. Contact between display device 102 and controller 112 through control circuit board 110 and connector 104 allows control information to be transmitted to display 102 so that the correct symbol can be displayed on the key.

FIG. 2B is a diagram illustrating assembled key 130 in a depressed position. As described above, when key 130 is pressed a portion of key switch 114 can be configured to shorts traces 120, 122 together. The connection of traces 120, 122 provide an electrical input indicating that the key has been pressed. The electrical input can then be transmitted to a computer or other electronic device connected to the keyboard. The electrical input can be transmitted using a “wired” connection such as a PS/2 connector, or a USB connection, or a wireless connection. Systems and methods for connecting keyboards to electronic devices, such as computers, are well known and, for brevity, will not be discussed further herein.

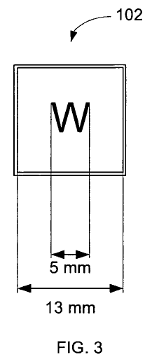

FIG. 3 is a diagram illustrating a view looking down on display device 102 of FIG. 1. The size of keys on a keyboard, numeric key pad, or other device using keys can vary from device to device as well as for different keys on a device. For example, many computer keyboards have several different sizes and shapes of keys, e.g., the “W” key can be a different size from the “Caps Lock” key, etc. Accordingly, in one embodiment, display device 102 can be configured such that it is approximately the same size as most of the keys on the keyboard. For example, the display portion of the device can, for example, be 13 mm wide, which is approximately the same size as most keys on a standard keyboard. Further, the display portion of the device can, for example, be square, or slightly rectangular, e.g., the display device can be approximately 13 mm high. Display device 102 can display the active function associated with the key with which it is incorporated. For example, a capital “W” 300 can be displayed on the “W” key when that key will enter a capital “W” when pressed, e.g., when the “shift” or “caps lock” modifiers are active.

Further, because only one symbol is being displayed on a key at any given time, the symbol can be made sufficiently large to allow for easy viewing. For example, the “W” symbol being displayed in FIG. 3 can be about 5 mm wide. The letter “W” in this example is shown approximately center on the display. On many keyboards the letters are displayed off center. The position of each of the letters, symbols, or other indicia of a keys functionality can vary. For example, in certain embodiments the letter position on display device 102 can be varied by a user based on that user's preference, including center, top left, top right, etc.

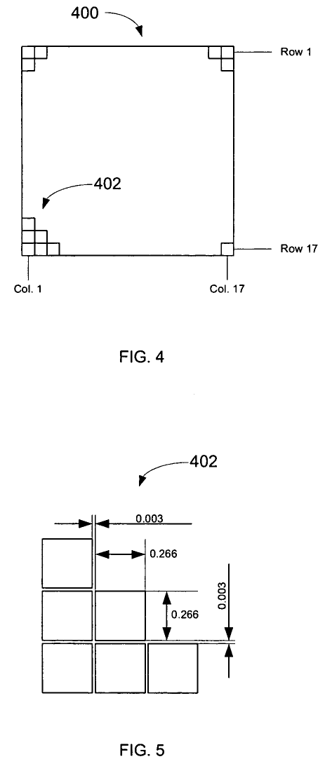

FIG. 4 is a diagram illustrating an example liquid crystal display (LCD) 400 that can be included as display device 102. LCD 400 can, for example, comprise a matrix of pixels. This matrix can, depending on the embodiment, be a 17×17 pixel matrix. Other matrices are clearly possible and selection of the matrix will depend on the requirements and limitations of a particular embodiment. In certain embodiments a “black and white” LCD display 400 can be used to form symbols, characters, and images. In such embodiments, each pixel can be dark or light to form the symbols and characters. Alternatively, LCD 400 can be a color LCD. A color LCD 400 can display symbols and characters in a variety of colors other than black and white. Additionally multiple color symbols, characters, and images can be displayed, if required.

FIG. 5 is a diagram further illustrating the pixels of LCD 400. The diagram of FIG. 5 shows 6 pixels 402 of LCD 400 and indicates example dimensions for each pixel. In this embodiment each pixel is 0.266 mm by 0.266 mm. Additionally, a gap of 0.003 mm exists between each pixel. It will be clear, however, that different LCD matrixes can be used and may have dimensions other than those shown and described with respect to the example of FIGS. 4 and 5.

In some embodiments it can be advantageous to use a display 102 that is almost as big as key 130. This would generally allow a larger character or symbol to be displayed. Alternatively, different users, or different manufacturers may wish to display characters and symbols under different portions of key 130. For example, many keyboards place each of the letters in the upper left hand portion of key 130. Accordingly, a display 102 can be smaller than key 130 and can be positioned on a portion of key 130 corresponding to the position at which the symbols are displayed. Further, because display devices can become more expensive as the size of the display increases it can be advantageous to use a smaller display on some or all of the keyboard keys.

It can also be advantageous to use a single size display. This can simplify ordering and stocking of materials and reduce costs. The trade off, of course, is that some of the keys will have a smaller display than is otherwise required. For example, the “Enter key” is generally larger than each of the “letter” keys on the keyboard, and can, therefore, use a larger display.

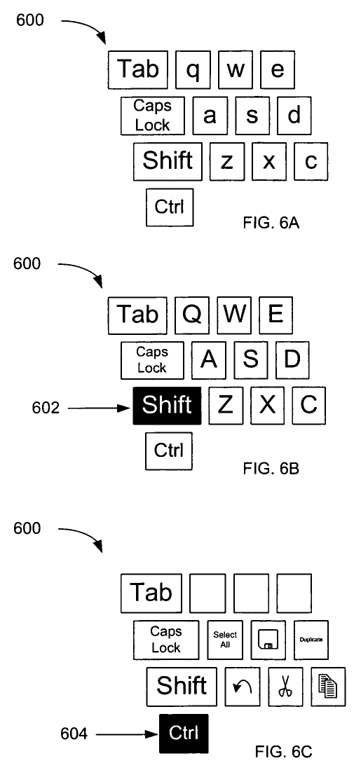

FIG. 6A-C are diagrams illustrating a portion 600 of a keyboard that uses keys 130 in accordance with one embodiment of the systems and methods described herein. Portion 600 of the keyboard that is shown includes the “Tab,” “Caps Lock,” “Shift,” and “Control” keys. Additionally, the keys generally referred to as the Q, W, E A, S, D, Z, X, and C keys are also shown. Referring now to FIG. 6A the lower cases letters q, w, e, a, s, d, z, x, and c are displayed, indicating to the user of the keyboard that when, for example, the “x” key is typed a lower case “x” will be input into the electronic device attached to the keyboard.

FIG. 6B illustrates the same portion 600 of a keyboard; however, in this example “Shift” key 602 has been pressed, as indicated by the darkening of the “shift” key. The darkening of the “shift” key is not necessarily intended to indicate that the “shift” key actually changes color or shading; however, in certain embodiments keys can be configured to change shading, coloring, etc. to indicate that they have been pressed or activated.

As illustrated in this example, when “Shift” key 602 is pressed each of the lettered keys changes to the upper case letters Q, W, E, A, S, D, Z, X, and C. This indicates that when any of these keys are pressed in conjunction with the “Shift” key 602 a capital letter, either Q, W, E, A, S, D, Z, X, or C will be input into the electronic device that the keyboard is attached to. This is in line with how many keyboards in the United States generally work, assuming that the “Caps Lock” key is “off” when the “Shift” key is pressed. Accordingly, keyboard 600 can be configured to give the user feedback about each keys function under specific conditions, for example, when the “Shift” key is pressed.

Keyboard 600, as discussed above, can have several different modifier keys. One example is the “Ctrl” key 604. In many applications, when “Ctrl” key 604 is pressed other keys on the keyboard can perform special functions. Thus, in certain embodiments such special functions can be displayed on each key when the appropriate modifier, e.g., “Ctrl” key 604, is pressed. The functions can be displayed graphically, e.g., a graphically symbol of a floppy disk for the save function, a graphical symbol of two pages for the copy function, a graphical symbol of scissors for the copy function, and a curving arrow for the undo typing. Functions can also be displayed using text, for example “Select All” and “Duplicate.”

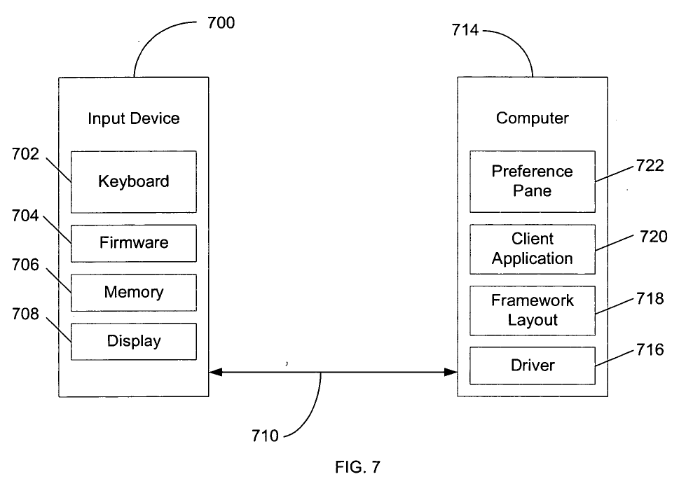

FIG. 7 is a diagram illustrating a system that includes an input device 700 incorporating a keyboard 702, such as keyboard 600, in accordance with one embodiment of the systems and methods described herein. As discussed above, keyboard 702 can be a keyboard, numeric keypad, or other keyed input device. Input device 700 can also include firmware 704. Firmware 704 can include instructions, stored in a memory 706 for displaying characters and symbols on a display 708. In addition to firmware, memory 706 can also be configured to store data, including layouts for different languages, such as English, French, Russian, etc. Memory 706 can also store maps of different functions available, for example, when “Shift-Option” or “Caps Lock” are pressed. Characters, A, B, C, $, @, etc. can also be stored in memory 706.

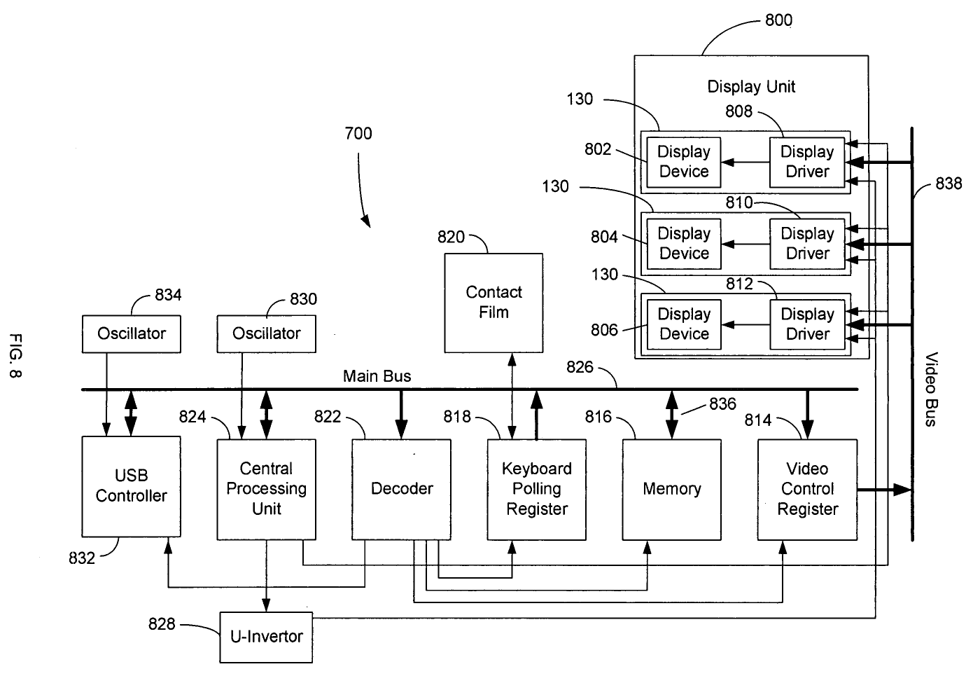

Display 708 can comprise one or more displays included in one or more keys, such as keys 130. Keys 130 can comprise keyboard 702. As discussed above, many different types of displays 708, such as liquid crystal displays, can be used to display keyboard information, including characters, symbols, and special functions. Further details of input device 700 will be discussed with respect to FIG. 8.

Input device 700 can be connected to an electronic device, such as computer 714, using connection 710. Connection 710 can, for example, be a USB connection, a Bluetooth connection, or other connection protocol, including wired PS/2, or other wired keyboard connection, or wireless infrared connection, to name just a few.

Computer 714 can be any electronic device that can use a keyboard for input. Generally, computer 714 can include a driver 716, framework layout 718, client application 720, and preference pane 722. Driver 716 can be a software program for controlling the interface between input device 700 and computer 714. Driver 716 can, for example, be configured to cause display or displays 708 on input device 700 to display keyboard information such as characters, symbols, and special functions. A framework layout 718 can be a bridge between driver 716 and client application 720. Framework layout 718 can be used with computers that run an operating system that requires Frameworks, such as Mac OS X.

Additionally, in Mac OS X it is generally not possible to organize a “callback” mechanism to provide a direct Operating System custom driver. Under Mac OS X a client application 720 can keep track of the state of the operating system by polling the operating system. The operating system state includes information such as which layout is active and what processes are running. In some other operating systems “callback” mechanisms are available. For example, Windows OS does not require a client application.

A preference pane 722 can be a window within an operating system. Within preference pane 722 different parameters related to input device's 700 functionality can be set. Preference pane 722 is terminology that can be used in relation to Mac OS X. Other operating systems can use different terminology, for example, Windows OS under the Control Panel.

FIG. 8 is a block diagram illustrating connectivity between the components of input device 700 in accordance with one embodiment of the systems and methods described herein. As can be seen, input device 700 can include a display unit 800. Display unit 800 can comprise one or more keys 130. Each key 130 can include a display, e.g., displays 802, 804, and 806, which can be coupled to display drivers 808, 810, and 812.

Displays 802, 804, and 806 and display drivers 808, 810, and 812 can comprise part of display unit 808. Display unit 800 can be connected to a video control register 814 that can comprise one or more display drivers. Each video control register 814 can be configured to store graphical data and transfers it to display drivers 808, 810, and 812. The data can be transferred using a video display bus 838. Alternatively, a serial connection can transfer data from video display register 814 to display drivers 808, 810, and 812. Display drivers 808, 810, and 812 control display device 802, 804, and 806, and cause information to be displayed on display 802, 804, 806. For example, if displays 802, 804, and 806 are LCDs then display drivers 808, 810, and 812 can be LCD drivers. Multiple video registers 814 can be connected to main bus 826. For example, in one embodiment 13 video control registers 814 can be used. Additionally, each video register 814 can be connected to multiple display drivers 808, 810, 812. In one embodiment each video control register can, for example, be connected to eight display drivers 808, 810, 812 within display unit 800. In one embodiment Video control register 814 can be on the main bus 826 as can be central processing unit 824. Having central processing unit 824 on the same main bus 826 as video control register 814 allows central processing unit 824 to read and write information to video control register 814. In one embodiment a serial connection can be used in place of main bus 826. Additionally, in another embodiment, main bus 826 and video bus 838 comprise a single bus.

A memory 816 can also be connected to the same bus as central processing unit 824. Memory 816 provides central processing unit 824 with the ability to store information including data and instructions as discussed above. Data stored in memory 816 can include layouts for different languages, such as English, French, Russian, etc. Memory 816 can also store maps of different functions available, for example, when “Shift-Option” or “Caps Lock” are pressed. Characters, A, B, C, $, @, etc. can also be stored in memory 816. In one embodiment memory 816 can comprise part of central processing unit 824. In another embodiment memory 816 can comprise a separate component. Additionally, in another embodiment memory 816 can comprise multiple devices that can be part of central processing unit 824, a separate component, or some combination thereof. Keyboard polling register 818 can be configured to scan the keyboard matrix to determine if any of the keys 130 have been activated, keys 130 can be activated by shorting traces on contact film 820 as discussed above with respect to dome switches.

A decoder 822 can be configured for address decoding; selectively enable different components in an electronic system such that data can be written to, and/or read from the component. For example, if central processing unit 824 needs to write to USB controller 832 in one embodiment decoder 822 can generate a signal that can enable USB controller 832. Central processing unit 824 can be configured to control the operation of input device 700 and can be interfaced with various support circuitry. For example, oscillator 830 can provide an input clock to control timing for processing unit 824 as well as other devices. Additional oscillators 834 can also be used to control timing, for example, of USB controller 832. As discussed above, a USB interface, or other type of keyboard connectivity can be used to connect input device 700 with a computer 714.

U-Invertor 828 can be a device that inverts a positive analog voltage. For example, many LCD's must be provided a negative voltage to function correctly. For example, many LCD's require −7.5 volts or −10 volts. U-invertor 828 can output the negative voltage required to operate such LCDs. Arrows connecting each device, e.g., 808, 810, 812, 814, 816, 818, 822, 824, and 832 can indicate reading from or writing to a device. For example, a bidirectional arrow 836 can indicate that memory can be read and written.

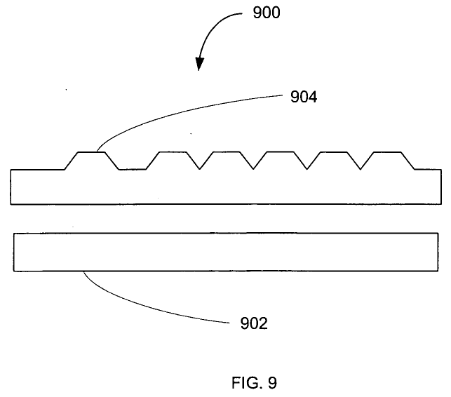

FIG. 9 is a diagram illustrating a keyboard 900 configured in accordance with another embodiment of the systems and methods described herein. Keyboard 900 includes a touch sensitive LCD 902, or other type of touch sensitive display device. A key cap skin 904 can be overlaid on top of touch sensitive LCD 902. Key cap skin 904 can provide tactile feedback to a user of keyboard 900. This tactile feedback can allow the user to determine the location of keys without looking at the keyboard. Some typists are, of course, better than others at typing without looking at the keyboard. Key cap skin 904 provides a similar look and feel to other keyboards.

Key cap skin 904 can be made of an opaque, or see through, material, such as plastic. The opaque, or see through material allows the user to see through the key cap skin and view the touch sensitive LCD 902 below. In this way a single LCD 902 can be used instead of one LCD display for each key. In some cases, this may be less expensive to manufacture since it can require fewer components, this will, however, generally depend on the price of the touch sensitive LCD 902 and the price of each of the displays 102 used in another embodiment.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A keyboard key, comprising:
a display configured to display symbols;
a controller coupled with the display, the controller configured to control the operation of the display; and
a control input coupled with the controller, the control input configured to provide information to the controller concerning what symbol is to be displayed on the display.

2. The keyboard key of claim 1, wherein the controller is further configured to cause the display to display a symbol based on the information received from the control input.

3. The keyboard key of claim 1, further comprising a key cap configured to fit over the display, wherein the key cap is made from a material that allows the display to be viewed through the key cap.

4. The keyboard key of claim 3, wherein the key cap is made from a material that is rugged enough to allow the keyboard key to be depressed repeatedly without damaging the display.

5. The keyboard key of claim 1, further comprising a key switch configured to provide an indication that the key has been depressed.

6. The keyboard switch of claim 1, wherein the display is a liquid crystal display, and wherein the controller is a liquid crystal display driver.

7. The keyboard key of claim 1, wherein the display comprises a micro-electromechanical system display device.

8. A computer input device, comprising:
a keyboard key, comprising:
a display configured to display a symbol,
a controller coupled with the display, the controller configured to control the operation of the display, and
a control input coupled with the controller, the control input configured to provide information to the controller concerning what symbol is to be displayed on the display; and
a processor configured to provide the information to the controller via the control input

9. The computer input device of claim 8, wherein the controller is further configured to cause the display to display a symbol based on the information received form the control input.

10. The computer input device of claim 8, further comprising a key cap configured to fit over the display, wherein the key cap is made from a material that allows the display to be viewed through the key cap.

11. The computer input device of claim 10, wherein the key cap is made from a material that is rugged enough to allow the keyboard key to be depressed repeatedly without damaging the display.

12. The computer input device of claim 8, further comprising a key switch configured to provide an indication that the key has been depressed.

13. The computer input device of claim 8, wherein the display is a liquid crystal display, and wherein the controller is a liquid crystal display driver.

14. The computer input device of claim 8, wherein the display comprises a micro-electromechanical system display device.

15. The computer input device of claim 8, further comprising a communication interface configured to connect the computer input device to a computer.

16. The computer input device of claim 8, wherein the communication interface is a universal serial bus interface.

17. The computer input device of claim 8, wherein the communication interface is a Bluetooth interface.

18. The computer input device of claim 8, wherein the communication interface is a PS/2 interface.

19. The computer input device of claim 8, wherein the communication interface is a wired interface.

20. The computer input device of claim 8, wherein the communication interface is a wireless interface.

21. The computer input device of claim 8, wherein the communication interface is a Firewire interface.

22. The computer input device of claim 8, further comprising a memory coupled with the processor, the memory configured to store a character map, wherein the processor is configured to use the character map to provide ht information to the controller.

23. A computer input device, comprising:
a touch sensitive display; and
a key cap skin coupled to the touch sensitive display and configured to provide an input to the touch sensitive display.

24. The computer input device of claim 23, wherein the key cap skin comprises a clear material that allows the touch sensitive display to be seen through the key cap skin.

25. The computer input device of claim 23, wherein the touch sensitive display and the key cap skin form a keyboard and wherein the touch sensitive display is configured to display symbols corresponding to the various keys of the keyboard.

26. The computer input device of claim 25, further comprising a processor, coupled with the touch sensitive display, the processor configure dot provide information to the touch sensitive display regarding what symbols to display.

27. The computer input device of claim 26, further comprising a display driver, wherein the processor is interfaced with the touch sensitive display via the display driver.

28. The computer input device of claim 26, further comprising a memory coupled with the processor, the memory configured to store information used by the processor to determine what symbol is to be displayed for each key.

29. The computer input device of claim 28, wherein the information stored in the memory includes a character map.

30. The computer input device of claim 23, wherein the touch sensitive display is a liquid crystal display.
